(19) United States
(12) Patent Application Publication
(10) Pub. No.: US 2019/0034306 A1
(43) Pub. Date: Jan. 31, 2019

(54) Computer System, Computer System Host, First Storage Device, Second Storage Device, Controllers, Methods, Apparatuses and Computer Programs

(71) Applicant: Intel Corporation, Santa Clara, CA (US)

(72) Inventors: Piotr Wysocki, Gdansk (PL); Slawomir Ptak, Gdansk (PL); Niels Reimers, Folsom, CA (US)

(21) Appl. No.: 15/663,923

(22) Filed: Jul. 31, 2017

(51) Int. Cl. G06F 11/20

(52) U.S. Cl. CPC G06F 11/2094; G06F 2201/82; G06F 2201/805

(57) ABSTRACT

Examples relate to a computer system, a computer system host, a first storage device, a second storage device, controllers, methods, apparatuses and computer programs. The computer system includes a first storage device and a second storage device. A storage region is distributed across the first storage device and the second storage device. The computer system further includes a computer system host. The computer system further includes a communication infrastructure configured to connect the first storage device, the second storage device and the computer system host. The computer system host is configured to transmit a request related to the storage region to the first storage device via the communication infrastructure. The first storage device is configured to issue a further request to the second storage device via the communication infrastructure to execute the request.

### FIELD

Examples relate to a computer system, a computer system host, a first storage device, a second storage device, controllers, methods, apparatuses and computer programs, more specifically, but not exclusively, to transmitting requests related to a storage region distributed across a plurality of storage devices between the storage devices of the plurality of storage devices.

### BACKGROUND

Data redundancy, e.g. within a Redundant Array of Independent Disks (RAID), may be used to add fault tolerance (for specific categories of faults) to a storage system. In case a storage device of a pool of storage devices fails, the data stored on this storage device can be recovered from the data stored on the remaining devices, and restored to a storage device replacing the failed storage device. A number of RAID configurations have been defined which may be used to account for different use cases and which may exhibit different levels of parity, from RAID 0 (no redundancy, a storage region spans multiple storage devices with no redundant data) or RAID 1 (full redundancy, mirroring of a storage region of one storage device to another storage region) to RAID 5 (parity information of the data is distributed across storage devices. If one storage device fails, its data may be recovered from the other storage devices).

### BRIEF DESCRIPTION OF THE FIGURES

Some examples of apparatuses and/or methods will be described in the following by way of example only, and with reference to the accompanying figures, in which

FIG. 1a illustrates a block diagram of a computer system;

FIG. 1b illustrates a flow chart of a method for a computer system;

FIG. 1c illustrates a block diagram of a controller for a first storage device;

FIG. 1d illustrates a flow chart of a method for a first storage device;

FIG. 1e illustrates a block diagram of a controller for a second storage device;

FIG. 1f illustrates a flow chart of a method for a second storage device;

FIG. 1g illustrates a block diagram of a computer system host;

FIG. 1h illustrates a flow chart of a method for a computer system host;

FIG. 2 shows an exemplary layout of a RAIDS volume distributed across three SSDs with RAID processing engines drives;

FIG. 3 shows a schematic diagram of PCIe drive-to-drive communication without involving host software;

FIG. 4a is composed of FIG. 4A-1 and FIG. 4A-2 and shows a flow chart of a flow for a RAIDS read operation according to an example;

FIG. 4b is composed of FIG. 4B-1 and FIG. 4B-2 and shows a flow chart of a RAIDS write with a read-modify write flow according to an example; and

FIG. 4c is composed of FIG. 4C-1 and FIG. 4C-2 and shows a flow chart of a flow for a RAID 5 full stripe write according to an example.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

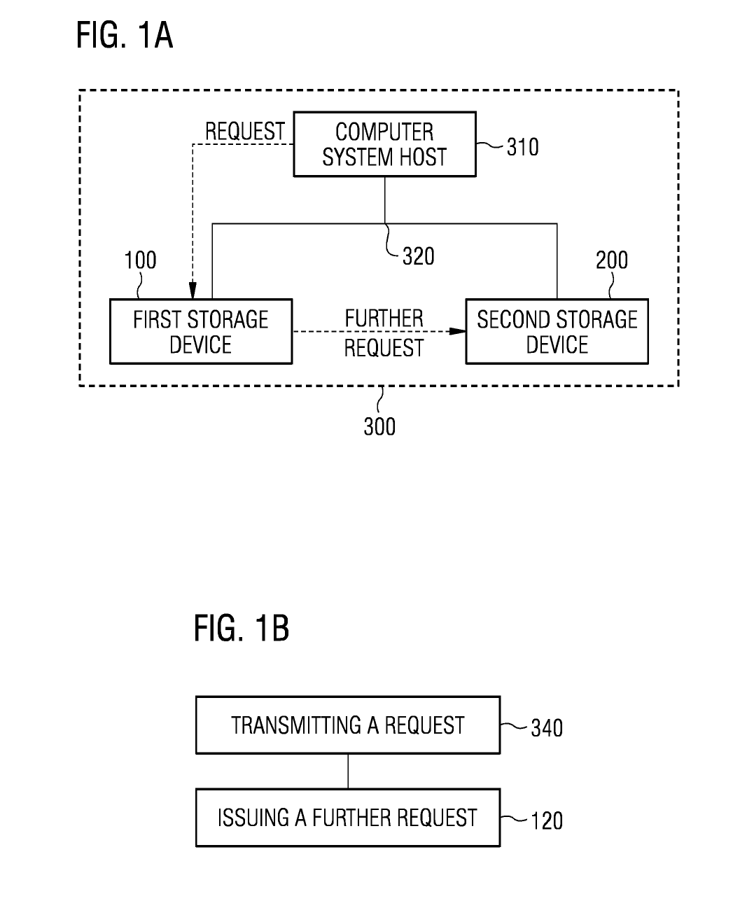

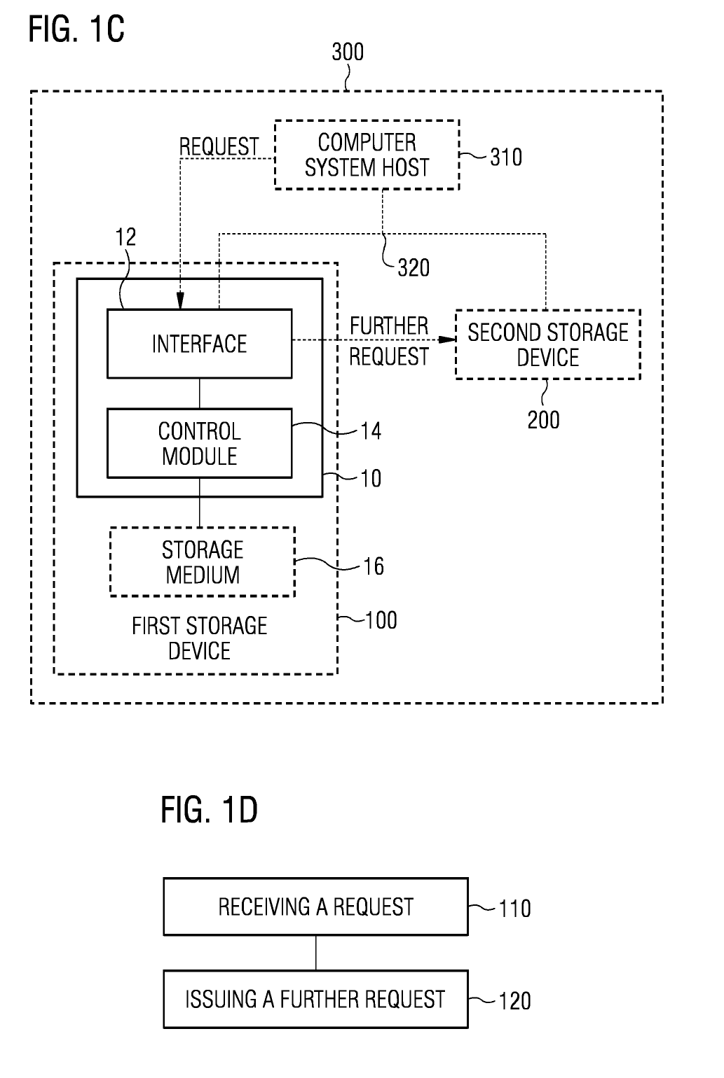

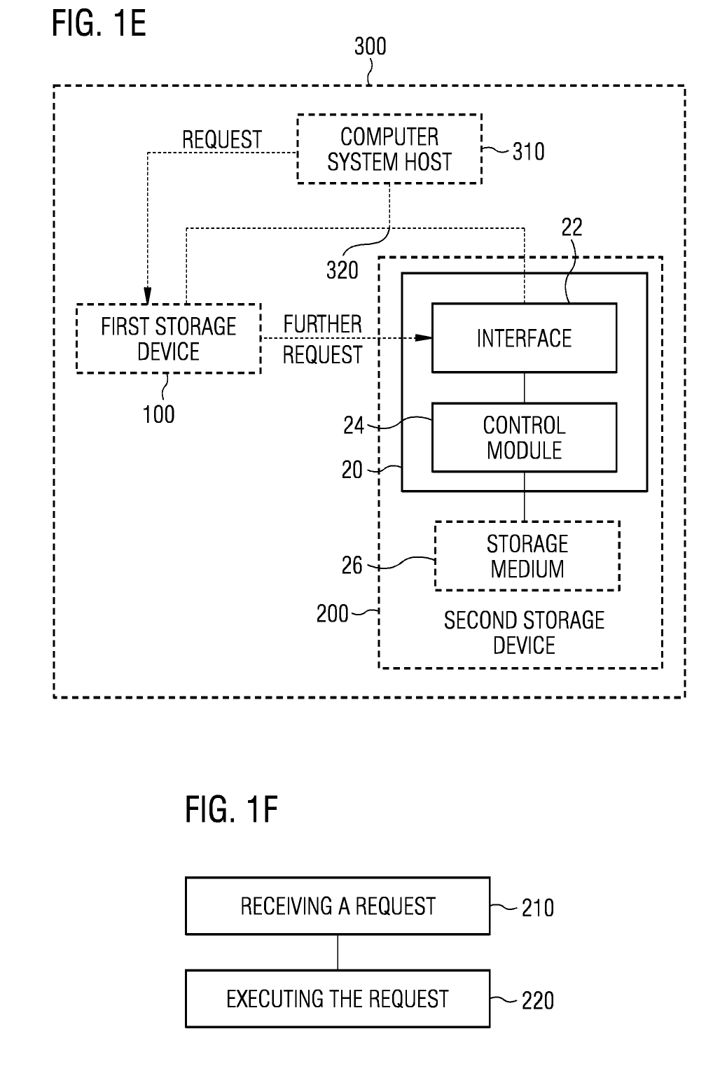

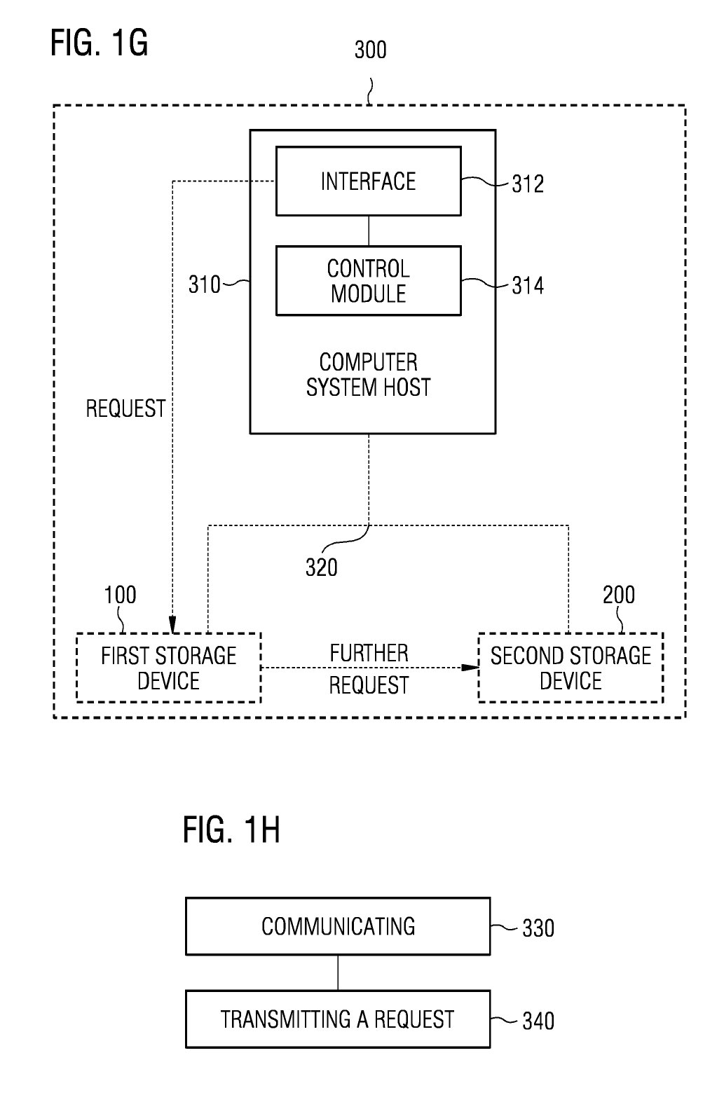

FIGS. 1a-1g illustrate examples of a computer system 300, a computer system host 310, a communication infrastructure 320, a first storage device 100 and a second storage device 200.

The described computer system host 310 corresponds to a computer system host apparatus 310, the described communication infrastructure 320 corresponds to a communication means 320, the described first storage device 100 corresponds to a first storage means 100 and the described second storage device 200 corresponds to a second storage means 200. Further, a controller 10 for the first storage device 100 corresponds to an apparatus 10 for the first storage means 100, a controller 20 for the second storage device 200 corresponds to an apparatus 20 for the second storage means 200. The components of the first storage means 100, second storage means 200, computer system host apparatus 310, controller 10 and controller 20 are defined as component means which correspond to the respective structural components of the first storage device 100, of the second storage device 200, of the computer system host 310, of the controller 10 and of the controller 20. In the following, various elements of the computer system 300 are introduced. Although they may be introduced using separate figures, at least parts of the following description may relate to any or all of the FIGS. 1a to 1h.

FIG. 1a illustrates a block diagram of an example of a computer system 300. The computer system 300 comprises a first storage device 100 and a second storage device 200. A storage region is distributed across the first storage device 100 and the second storage device 200. The computer system 300 further comprises a computer system host 310. The computer system 300 further comprises a communication infrastructure 320 configured to connect the first storage device 100, the second storage device 200 and the computer system host. The computer system host 310 is configured to transmit a request related to the storage region to the first storage device 100 via the communication infrastructure 320. The first storage device 100 is configured to issue a further request to the second storage device 200 via the communication infrastructure 320 to execute the request. FIG. 1b illustrates a flow chart of a corresponding method according to an example. The method comprises transmitting 340 the request related to the storage region to the first storage device 100 via the communication infrastructure 320. The method further comprises the first storage device 100 issuing 120 the further request to the second storage device 200 via the communication infrastructure 320 to execute the request.

Using the first storage device to relay requests related to the storage region to the second storage device (or to a plurality of second storage devices) may enable a hardware-based RAID (Redundant Array of Independent Disks) without the need for an additional RAID controller and without immediate involvement of the computer system host. This may decrease an amount of processing performed by the computer system host, reduce the bill of materials for such a system, and may avoid having a single point of failure within the system.

In various examples, the computer system 300 may be a general-purpose computer system, e.g. a personal computer, a laptop computer or a personal workstation. Alternatively, the computer system 300 may be a server computer system, e.g. a storage server, an application server, a storage access network or a general purpose server.

For example, the first storage device 100 and/or the second storage device 200 may comprise storage media 16; 26 for storing data related to the storage region. For example, the first storage device 100 and/or the second storage device 200 may be Solid Stage Drive (SSD)-based storage systems, e.g. the storage media 16; 26 may comprise solid-state memory/NAND flash memory. A solid state drive has nonvolatile memory which retains data stored in the nonvolatile memory notwithstanding a power loss to the storage drive. The non-volatile memory may be NAND-based flash memory. The first storage device 100 and/or the second storage device 200 may comprise non-volatile memory (e.g. within the storage media 16; 26). In one example, the storage medium 16 and/or the storage medium 26 is a block addressable memory device, such as those based on NAND or NOR technologies. A storage medium may also include future generation nonvolatile devices, such as a three dimensional crosspoint memory device, or other byte addressable write-in-place nonvolatile memory devices. In one example, the storage medium 16 and/or the storage medium 26 may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Do-main Wall) and SOT (Spin Orbit Transfer) based device, a thiristor based memory device, or a combination of any of the above, or other memory. The storage medium 16 and/or the storage medium 26 may refer to the die itself and/or to a packaged memory product. For example, the first storage device 100 and/or the second storage device may be one of a Non-Volatile Memory express (NVMe)-based storage device, a Serial Attached Small computer system interface (SAS)-based storage device, an Open Channel SSD (OCSSD) storage device, a SCSI over PCIe (SOP) storage device, an iSCSI extensions for RDMA storage device or a Serial AT Attachment (SATA)-based storage device. Non-Volatile Memory Express (NVMe) is a logical device interface (http://www.nvmexpress.org) for accessing non-volatile storage media attached via a Peripheral Component Interconnect Express (PCIe) bus (http://www.pcsig.com). The non-volatile storage media may comprise a flash memory and solid solid-state drives (SSDs). NVMe is designed for accessing low latency storage devices in computer systems, including personal and enterprise computer systems, and is also deployed in data centers requiring scaling of thousands of low latency storage devices. At least some examples may be applicable to any storage protocol over PCIe, e.g. NVMe, Open Channel SSD (OCSSD) and SCSI over PCIe (SOP). Examples may further be supported on Ethernet with iSER (internet SCSI (iSCSI) extensions for remote DMA (RDMA)) and RDMA. Examples may utilize RDMA and SCSI to deliver the data traffic (SCSI) and peer to peer traffic (RDMA) that may be required. Alternatively or additionally, the first storage device 100 and/or the second storage device 200 may comprise rotational drives as storage module 16 and/or as storage medium 26, or the first storage device 100 and/or the second storage device 200 may comprise Random Access Memory (RAM) based memory as storage module 16 and/or as storage medium 26. The first storage device 100 may comprise a first storage module (e.g. the storage medium 16) and the second storage device 200 comprise a second storage module (e.g. the storage medium 26). The storage region may be distributed across the first storage module and the second storage module. For example, a capacity of the first storage module may be substantially equal to a capacity of the second storage module. The capacity of the first storage region may differ by less than 10% from the capacity of the second storage region, for example. In at least some examples, a portion of the storage region stored on the first storage device 100 comprises parity information, e.g. parity data of a RAID 5 configuration or parity information/mirrored data of a RAID 1 configuration. A portion of the storage region stored on the second storage device 200 may comprise (non-parity) data. For example, the parity information stored on the first storage device 100 may be related to the (non-parity) data stored on the second storage device 200 (or non-parity data stored on multiple second storage devices 200). For example, the storage region may be distributed across the first storage device 100 and the second storage device 200 so that the parity information of the storage region is stored on the first storage device 100 and the (nonparity) data of the storage region is stored on the second storage device 200 (or the multiple/two or more second storage devices 200). For example, the storage region may be a logically-coherent storage region, e.g. a stripe of a stripe-based RAID.

For example, the storage region may be a stripe of a Redundant Array of Independent Disks, RAID. The first storage device 100 may be a processor master of the RAID for the storage region, e.g. the owner of the storage region. The second storage device 100 may be a processor slave of the RAID for the storage region. Using the first storage device 100 as a processor master of the RAID may enable a hardware-based execution of (most) RAID functionality, and may thus reduce an amount of processing required at the computer system host 310. Also, no single point of failure may be present in the system, as the computer system host 310 may be configured to intermittently take over the processor master duties from the first storage device 100 in case of failure of the first storage device 100. For example, the RAID may comprise at least the storage region and a second storage region being the stripes of the RAID. For example, the RAID may comprise a first stripe (e.g. the storage region) and a second stripe (e.g. the second storage region). The first stripe and the second stripe may have different owners (or processor masters), e.g. the first storage device 100 may be the owner/processor master for the first stripe and the second storage device 200 may be the owner/processor master for the second stripe. For example, the storage region and the second storage region may be stripes of a (volume of a) RAID. The second storage region may be distributed across the first storage device 100 and the second storage device 200. The computer system host 310 may be configured to transmit a second request related to the second storage region to the second storage device 200 via the communication infrastructure 320. The second storage device 200 may be configured to issue a second further request to the first storage device 100 via the communication infrastructure 320 to execute the second request. The issuing of the second further request may be implemented similar to the issuing of the (first) further request by the first storage device 100. For example, the first storage device 100 may be a processor slave of the RAID for the second storage region. The second storage device 200 may be a processor master of the RAID for the second storage region, e.g. the owner of the second storage region. This may distribute the processing load caused by a RAID over the first and second storage device.

In various examples, the first storage device 100 may comprise a controller for controlling the first storage device 100. FIG. 1c shows a block diagram of a controller 10 for the first storage device 100. The controller 10 comprises an interface 12 configured to receive, via the communication infrastructure 320, the request related to the storage region distributed across the first storage device 100 and the second storage device 200 from the computer system host 310. The controller 10 further comprises a control module 14 configured to issue a further request to the second storage device 200 via the communication infrastructure 320 to execute the request. The control module 14 may be further configured to execute the further actions of the first storage device 100 as described below or above, e.g. method steps of a method for the first storage device 100. Examples further provide the first storage device 100 comprising the controller 10 for the first storage device. The first storage device 100 may further comprise the storage medium 16. In at least some examples, the storage medium 16 may correspond to a means for storing data, e.g. a storage means 16. The storage medium 16 may comprise nonvolatile memory, e.g. three-dimensional crosspoint memory or NAND memory as described above. The control module 14 may be coupled to the interface 12 and to the storage medium 16. FIG. 1d shows a flow chart of the corresponding method for the first storage device 100. The method comprises receiving 110, via the communication infrastructure 320, the request related to the storage region distributed across the first storage device 100 and the second storage device 200 from the computer system host 310. The method further comprises issuing 120 the further request to the second storage device 200 via the communication infrastructure 320 to execute the request.

For example, the second storage device 200 may comprise a controller for controlling the second storage device 200. FIG. 1e shows a block diagram of a controller 20 for the first storage device 200. The controller 20 comprises an interface 22 configured to receive a request (e.g. the further request transmitted by the first storage device 100) related to the storage region distributed across the first storage device and the second storage device from the first storage device 100 via the communication infrastructure 320. The controller 20 further comprises a control module 24 configured to execute the request related to the storage region on a portion of the storage region stored on the second storage device 200. The control module 24 may be further configured to execute the further actions of the second storage device 200 as described below or above, e.g. method steps of a method for the first storage device 100. Examples further provide the second storage device 200 comprising the controller 20 for the second storage device. The second storage device 200 may further comprise the storage medium 26. In at least some examples, the storage medium 26 may correspond to a means for storing data, e.g. a storage means 26. The storage medium 26 may comprise non-volatile memory, e.g. three-dimensional crosspoint memory or NAND memory as described above. The control module 24 may be coupled to the interface 22 and to the storage medium 26. FIG. 1f shows a corresponding method for the second storage device 200. The method comprises receiving 210 a request (e.g. the further request transmitted by the first storage device 100) related to a storage region distributed across the first storage device and the second storage device from the first storage device 100 via the communication infrastructure 320. The method further comprises executing 220 the request related to the storage region on a portion of the storage region stored on the second storage device 200.

For example, the computer system 300 may comprise two or more second storage devices 200. The storage region may be distributed across the first storage device 100 and the two or more second storage devices 200. The first storage device 100 may be configured to issue the further request to at least one of the two or more second storage devices 200.

For example, the first storage device 100 may comprise the controller 10 for handling requests related to the (first) storage region and the controller 20 for handling requests related to a second storage region. The second storage device 200 may comprise the controller 20 for handling requests related to storage region and the controller 10 for handling requests related to the second storage region.

In various examples, the request and/or the further request may comprise at least one element of the group of a request to write data to the storage region, a request to read data from the storage region and a request to update/modify data within the storage region. For example, the request may comprise a single (write/read/modify) instruction, or it may comprise a plurality of instructions, e.g. a combined read-modify-write instruction. For example, the computer system host 310 may be configured to split a multi-part request to a plurality of requests (e.g. based on which storage region the requests related to), and to transmit the requests of the plurality of requests to the first storage device 100 which relate to the storage region distributed across the first storage device 100 and the second storage device (and “owned” by the first storage device).

For example, the computer system host 310 may be an operating system of the computer system or a part of the operating system, e.g. a storage driver of the computer system 300. In at least some examples, the computer system host 310 may be implemented in software. FIG. 1g shows a block diagram of the computer system host 310 according to an example. The computer system host 310 may comprise at least one interface 312 configured to communicate via a communication infrastructure 320. The computer system host may further comprise a control module 314 configured to transmit the request related to the storage region distributed across the first storage device 100 and across the second storage device 200 to the first storage device 100 via the communication infrastructure 320 if the request is related to a portion of the storage region stored on the second storage device 200. The control module 314 may be further configured to execute the further actions of the computer system host 310 as described below or above, e.g. method steps of a method for the computer system host 310. FIG. 1h shows a flow chart of the (corresponding) method for the computer system host 310. The method comprises communicating 330 via the communication infrastructure 320. The method further comprises transmitting 340 the request related to the storage region distributed across the first storage device 100 and the second storage device 200 to the first storage device 100 via the communication infrastructure 320 if the request is related to a portion of the storage region stored on the second storage device 200.

In various examples, the first storage device 100 is configured to issue the further request to the second storage device 200 if the request is related to a portion of the storage region stored on the second storage device 200, e.g. if it is related to a portion of the storage region comprising non-parity data stored on the second storage device 200. This may enable a relaying or forwarding of the request if the second storage device 200 is to be involved. The first storage device 100 may be configured to execute the request if the request is related to a portion of the storage region stored on the first storage device. If the request can be fulfilled by the first storage device 100 alone, it may be configured to execute the request without involving the second storage device 200.

In various examples, the further request may be based on the request. For example, the further request may comprise a portion of the request, or may be derived from the request. The issuing of the further request to the second storage device 200 may comprise determining whether the request is related to a portion of the storage region stored on the second storage device 200 (e.g. by analyzing the request). The issuing of the further request may further comprise transforming the request into the further request for the second storage device 200 (e.g. by extracting a portion of the request related to (non-parity) data stored on the second storage device 200). The issuing of the further request may further comprise transmitting the further request to the second storage device 200 using the communication infrastructure 320. For example, the first storage device 100 may be configured to split up and/or reformulate the request for the second storage device, e.g. to reduce a size of the further request and/or to reduce an amount of processing (and required circumstantial information) required by the second storage device 200.

In some examples, the further request may be a forwarded version of the request, e.g. the entire request or parts of the request. The issuing of the further request to the second storage device 200 may comprise determining whether the request is related to a portion of the storage region stored on the second storage device 200 and forwarding (at least parts of) the request as further request to the second storage device 200 using the communication infrastructure 320. Forwarding the request may reduce an amount of processing to be performed by the first storage device 100.

In various examples, the second storage device 200 may be configured to notify the first storage device 100 after completing the further request. For example, the second storage device 200 may be configured to write to a completion queue of the second storage device and to “ring the doorbell” at the first storage device after completing execution of the further requests. Alternatively, the second storage region may be configured to notify the first storage device 100 without involving the completion queue of the second storage device. Alternatively, the computer system 300 may comprise a completion queue for requests from the first storage device to the second storage device, and the second storage device may be configured to write the completion notification to the completion queue for the requests from the first storage device to the second storage device.

The first storage device 100 may be configured to notify the computer system host 310 after the request is complete, e.g. by writing to a completion queue of the first storage device 100 or by writing to a completion queue for the storage region. This may reduce a processing required by the computer system host, as the first storage device may collect (all) completion notifications from the (or multiple) second storage device 200 before notifying the host after the request has been completed.

In various examples, the second storage device 200 and/or the first storage device 100 may be configured to read data related to the further request or data related to the request (directly) from a memory of the computer system host 310 (e.g. without involving the computer system host 310, without invoking an interrupt at the computer system host 310, and/or by using Direct Memory Access, DMA). The second storage device 200 may be configured to write data related to the further request or related to the request (directly) to a memory of the computer system host 310 (e.g. without involving the computer system host 310, without invoking an interrupt at the computer system host 310, and/or by using DMA). This may reduce an involvement of the first storage device 100 in data read/write operations.

In at least some examples, the first storage device 100 may be configured to read parity information related to the request from a memory of the computer system host 310. For example, the parity information may be parity information written by the computer system host 310 itself, or written by the second storage device 200. For example, if the parity information originates from the computer system 310, the first storage device 100 may be configured to write the parity information to a storage of the first storage device 100, e.g. updating previous/old parity information stored on the first storage device 100. For example, if the parity information originates from the second storage device 200, the first storage device 100 may be configured to combine the storage information with parity information stored on the first storage device 100 to update/modify the parity information stored on the first storage device 100.

For example, the computer system host 310 may be configured to determine new parity information based on the request and to provide the new parity information to the first storage device 100, e.g. by writing the new parity information as parity information to the memory of the computer system host 310. This may reduce an amount of transactions required in updating the parity information within the first storage device 100. For example, if the parity information can be derived from the request provided by the computer system host 310, the computer system host 310 may be configured to provide the new parity information to the first storage device 100.

In various examples, the second storage device 200 may be configured to determine new parity information related to the further request. For example, the new parity information may be a logical combination of data written during the execution of the request and data previously stored on the second storage device 200, e.g. an exclusive-or (XOR) combination.

The second storage device 200 may be configured to write the new parity information to a memory of the computer system host 310 (as parity information). The first storage device may be configured to read the new parity information from the memory of the computer system host 310.

For example, the second storage device 200 may be configured to XOR (perform an exclusive or-operation) previously stored data and new data, and to write the result to a memory of the computer system host for the first storage device.

For example, the first storage device 100 and/or the second storage device 200 may be configured to communicate via a non-volatile memory express (NVMe) communication protocol. For example, the first storage device 100 and/or the second storage device 200 may be configured to communicate using one or more queues (e.g. a submission queue or a completion queue) of the NVMe protocol.

This may enable using the submission and completion queues of the NVMe protocol for transmitting the (further) request and for transmitting the completion notifications.

In various examples, the first storage device 100 may comprise a transmission queue for transmissions to the second storage device 200. For example, the transmission queue may comprise data to be sent to the second storage device 200 from the first storage device 100. This may enable or facilitate the issuing of the further request. For example, the transmission queue may be stored within a memory of the computer system host 310. For example, a virtual memory of the computer system host 310 may comprise a portion related to a submission queue and of a completion queue for transmission from the first storage device 100 to the second storage device 200. For example, the portion of the virtual memory may be mapped to the memory of the computer system host 310, or it may be mapped to a memory of the second storage device 200. To transfer data (e.g. the further request) to the second storage device 200, the first storage device 100 may be configured to write the data to the submission queue for the second storage device, and “ring the doorbell” at the second storage device (by writing to a memory of the second storage device 200).

For example, the computer system host 310 may be configured to transmit the request related to the storage region by writing the request to a submission queue of the first storage device, and by “ringing the doorbell” of the first storage device 100 (via the communication infrastructure 320). The first storage device 100 may be configured to fetch the request from the submission queue (via the communication infrastructure 320).

The first storage device 100 may be configured to issue the further request to the second storage device 200 by writing the further request to a submission queue of the second storage device 200 (via the communication infrastructure 320) and to “ring the doorbell” at the second storage device 200 (via the communication infrastructure 320). The second storage device 200 may be configured to fetch the further request from the submission queue of the second storage device 200 (via the communication infrastructure 320). Upon completion of the further request, the second storage device 320 may be configured to write a completion notification to a completion queue of the second storage device 200.

FIG. 1a further shows a distributed redundant array of independent disks (RAID) comprising the first storage device 100 and the second storage device 200. The storage region is distributed across the first storage device 100 and the second storage device 200. The first storage device 100 may be a (RAID) processor master for the storage region and wherein the second storage device 200 may be a (RAID) processor slave for the storage region.

In various examples, the communication infrastructure 320 may be a communication bus or point-to-point communication infrastructure of the computer system 300. For example, the communication infrastructure may be a serial transmissions-based communication infrastructure 320. In some examples, the communication infrastructure might not be a bus-system. The communication infrastructure may be a point to point (peer to peer) communication infrastructure. The first storage device 100 may be configured to issue the further request to the second storage device 200 using a peer-to-peer connection between the first storage device 100 and the second storage device 200. For example, the first storage device 100 may be configured to write the further request to a portion of a virtual memory of the computer system host 300 allocated to the second storage device 200. For example, the portion of the virtual memory may relate to a portion of a memory of the computer system host 310. Alternatively, the portion of the virtual memory may relate to a portion of a memory of the second storage device 200. The first storage device 100 may be further configured to “ring the doorbell” at the second storage device 200, e.g. by writing a notification to a further portion of the virtual memory of the computer system host mapped to a further portion of the memory of the second storage device 200. The first storage device 100 may be configured to issue the further request to the second storage device 200 without involving the computer system host 310 and/or without involving a central processing unit of the computer system. Accessing the memory of the computer system host might not be considered involving the computer system host 310. For example, involving the computer system host 310 may comprise invoking an interrupt handler of the computer system host 310.

In at least some examples, the communication infrastructure is a Peripheral Component Interconnect express (PCIe) communication infrastructure. For example, the first storage device 100, the second storage device 200 and the computer system host 300 may be configured to communicate over PCIe.

Using (PCIe) direct transmission between the first storage device 100 and the second storage device 200 may reduce an involvement of the computer system host 310 in the execution of the request.

The interface 12, the interface 22 and/or the interface 312 may correspond to one or more means for communicating, one or more communication means, one or more inputs and/or outputs for receiving and/or transmitting information, which may be in digital (bit) values according to a specified code, within a module, between modules or between modules of different entities.

In examples the control module 14, the control module 24 and/or the control module 314 may be implemented using one or more processing units, one or more processing devices, any means for processing, such as a processor, a computer or a programmable hardware component being operable with accordingly adapted software. In other words, the described function of the control module 14; 24; 314 may as well be implemented in software, which is then executed on one or more programmable hardware components. Such hardware components may comprise a general purpose processor, a Digital Signal Processor (DSP), a micro-controller, etc.

At least some examples relate to a PCIe peer-to-peer based hardware-assisted NVMe RAID. Examples may for example use one or more elements of a completion queue, a submission queue, NVMe, parity (information), PCIe, peer-to-peer (transmissions), RAID, redundancy, Solid State Drives, and may for example provide a high reliability. Examples may be implemented using a Rapid Storage Technology (RST) driver, for example.

Various examples may facilitate enabling NVMe drives for use in enterprise datacenter environments requiring high reliability storage, which may currently mostly use SAS (Serial Attached SCSI, Small Computer System Interface) based approaches. At least examples may provide a notion of HBA (Host-Bus-Adaptor) or ROC (RAID On Chip) controller processing RAID I/O operations flows, which might not consume host CPU cycles and might not be a noisy tenant for other applications running on a host, which may be an impediment to adopting NVMe drives in these environments as some RAID approaches for NVMe may be mostly software based.

Some systems may provide a single HBA controller dedicated for NVMe drives; however this (and e.g. SAS HBAs) may be a single point of failure, and may be an additional device in the system increasing TCO (Total Cost of Ownership), introduce additional BUM (Bill of Materials) cost and power consumption.

At least some examples may offer improvements compared to hardware host-bus-adapters and pure software approaches.

Various examples may provide a software assisted hardware RAID for local NVMe devices based on extended functionality of NVMe drives with a RAID processing engine and PCIe drive-to-drive communication. Such drives may be denoted NVMe-R or “SSD with RAID processing engine” (and NVMe protocol for communicating with host system and other SSDs over a PCIe bus) in the following. At least some example may support all known RAID levels+additional high reliability RAID levels based on Erasure Coding algorithms.

RAID logic may be distributed across all PCIe SSDs with RAID processing engines member disks (e.g. the first storage device 100 and/or the second storage device 200) plus a lightweight software module (e.g. the computer system host 310) on a host side. Each RAID stripe (e.g. the storage region) may have its designated owner (e.t. the first storage device 100)—a RAID processing engine located on one of NVMe drives (e.t. the first storage device 100) which location is known both by host (e.g. the computer system host 310) and drives sides (e.g. the first storage device 100 and/or the second storage device 200).

Host side lightweight RAID logic (e.g. of the computer system host 310) may be comprised in an NVMe or VMD (Volume Management Device) driver or as a separate module in a software storage stack that is aware of the layout of RAID volume (number of member disks, size of RAID strip, volume size). The term “lightweight RAID logic” may refer to a RAID logic, in which computing-intensive tasks have been offloaded from the host to the drive controllers of the storage devices used. The lightweight RAID logic may split an incoming I/O (Input/Output) request, if necessary, and may submits it to proper RAID stripe owner (SSD with RAID processing engine, e.g. the first storage device 100) for further processing.

If the RAID processing engine located on an SSD with RAID processing engine (e.g. the first storage device 100) requires additional requests to multiple drives to fulfill RAID flows (like read-modify-write) then those requests may be submitted autonomously by this drive to another RAID member drive (e.g. the second storage device 100 or multiple second storage devices 200) using PCIe peer-to-peer communication and e.g. without involvement of host CPU in the action.

RAID processing engines (located on the SSD with RAID processing engine, e.g. the first storage device 100 and/or the second storage device 200) may send completions of the entire flow of a given I/O against a given RAID stripe to the host side lightweight logic (e.g. notify the computer system host 310). The host side lightweight logic may return the completion to upper layers of a storage stack when all completions from RAID processing engines are collected.

In case of errors during I/O processing (e.g. drive failure), the host side lightweight RAID logic (e.g. the computer system host 310) may detect and manage errors using SSDs with RAID processing engines as needed for error processing.

At least some examples might:
Provide hardware RAID with NVMe drives
Have no single point of failure
Provide a higher performance than existing SAS or NVMe RAID approaches
Scale performance and reliability with drive count
Provide a lower component cost compared with SAS software or hardware RAID approaches

Examples may provide a hardware ROC approach for NVMe drives. There might be no single point of failure as may be the case with HBA and ROC approaches. SAS approaches may require an HBA or ROC, which may be a performance bottleneck when connected to solid state drives. At least some examples might not require a HBA or ROC and might work with full performance utilizing all available PCIe lanes in a system (including multiprocessor systems). Various examples may also provide a higher performance than software based NVMe RAID approaches due to offloading data intensive operations to the SSDs with RAID processing engines. Software RAID approaches may consume significant CPU cycles and may behave like noisy tenants in a system due to host CPU cache trashing and necessity of handling IRQs (Interrupt Requests) coming from member disks, especially in the case of complex multistage RAID I/O flows like read-modify-write. In at least some examples, complex RAID operations may be performed by the SSDs with RAID processing engines, which may deliver a higher performance and more consistent QoS (Quality of Service) than software approaches. At least some examples may be better scalable compared to centralized approaches. In various examples, the RAID logic may be distributed across all member disks (e.g. across the first storage device 100 and one or more second storage devices 200)—the more disks that are members of a RAID volume, the more RAID compute power may be available. Reliability may similarly be scaled with an increase in the number of drives as the overall reliability may be related to the inverse of the number of drives in the system. SAS RAID systems may require an HBA for software based RAID or a ROC for hardware based RAID in addition to the drives required for the system. HBAs and ROCs may be complex systems including processors, high speed interfaces, memory, discrete components and sometimes battery backup. At least some examples may remove the need for an HBA or ROC, which may reduce the number of components in the system and the associated cost and power.

At least some examples may comprise:
A host side lightweight RAID logic (e.g. the computer system host 310) which may be aware of the RAID volume layout (RAID volume type and size, number of member drives and their identities, strip size and volume state). It may be in charge of splitting incoming RAID I/O request into sub-requests if needed and submit them to proper SSDs with RAID processing engines which are owners (e.g. the storage device 100) of particular RAID stripes (e.g. the storage region). It may also be in charge of handling (all) error cases.
A number of SSDs with RAID processing engines (e.g. the first storage device 100 and/or the second storage device 200) comprising RAID processing engines capable to dispatch RAID I/O against a given RAID stripe and process entire flow of a given RAID operation.

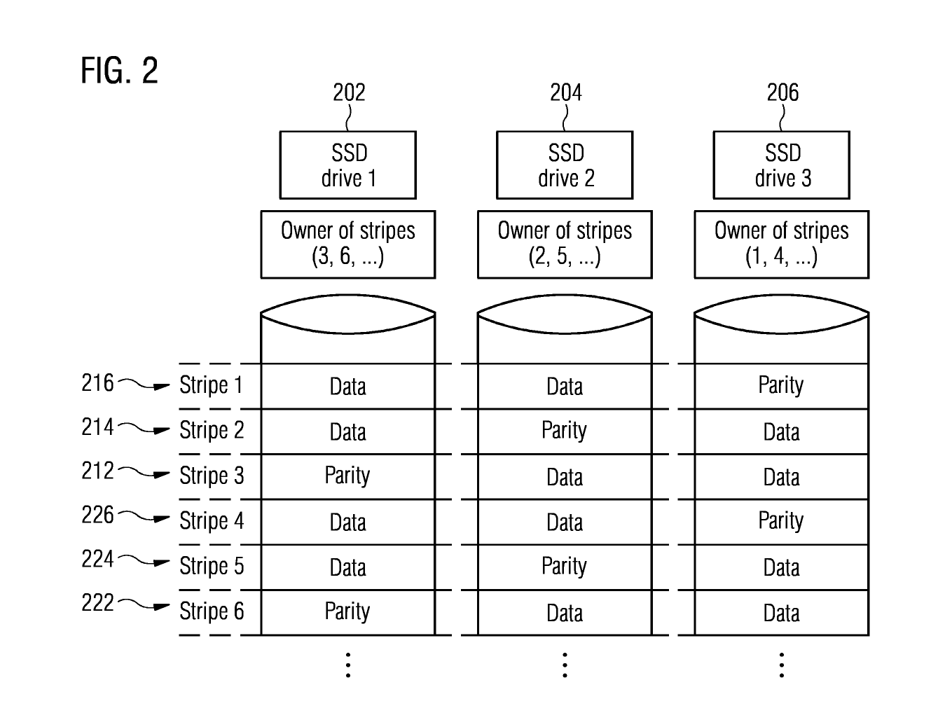

FIG. 2 shows an exemplary layout of a RAIDS volume distributed across three SSDs with RAID processing engines. FIG. 2 shows three SSDs with RAID processing engines 202, 204 and 206. SSD with RAID processing engine 202 may be the owner of RAID stripes 3 212 and 6 222, SSD with RAID processing engine 204 may be the owner of RAID stripes 2 214 and 5 224, and SSD with RAID processing engine drive 206 may be the owner of RAID stripes 1 216 and 4 226. The owner of a stripe may comprise parity information for that stripe while the other drives may comprise (non-parity) data. For example, for RAID stripes 1 and 4 (e.g. storage regions distributed across the first storage device and multiple second storage devices), SSD with RAID processing engine 206 may be implemented similar to the first storage device 100 and SSDs with RAID processing engines 202 and 204 may be implemented similar to the second storage device 200. For RAID stripes 2 and 5 (e.g. storage regions distributed across the first storage device and multiple second storage devices), SSD with RAID processing engine 204 may be implemented similar to the first storage device 100 and SSDs with RAID processing engines 202 and 206 may be implemented similar to the second storage device 200. For RAID stripes 3 and 6 (e.g. storage regions distributed across the first storage device and multiple second storage devices), SSD with RAID processing engine 202 may be implemented similar to the first storage device 100 and SSDs with RAID processing engines 204 and 206 may be implemented similar to the second storage device 200.

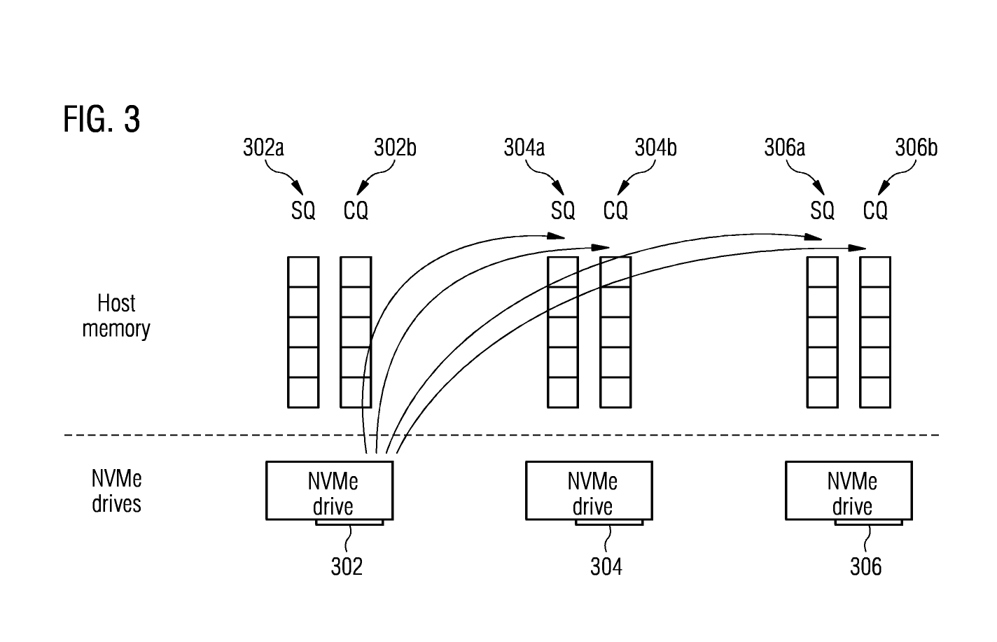

Each SSD with RAID processing engine member drive may be configured to initiate and respond to PCIe drive-to-drive communication without involving host software in the action (FIG. 3). FIG. 3 shows three NVMe drives 302; 304; 306 with their respective submission queues (SQ) 302a; 304a; 306a and their respective completion queues (CQ) 302b; 304b; 306b in host memory 308 (e.g. of the computer system host 310). NVMe drive 302 (e.g. the first storage device 100) may access the submission queues and/or completion queues in host memory (e.g. in issuing the further request) of drives 304 and 306 (which may be implemented similar to the second storage device 200). Afterwards, the NVMe drive 302 may “ring the doorbell” of drives 304; 306 using PCIe drive-to-drive communication.

SSDs with RAID processing engines of at least some examples may comprise three types of queue pairs:
Admin Queue: May be a regular Admin Queue as described in the NVMe specification, used to provide management communication between host and drive, with some additional commands described below
Host <-> Drive JO queues: May be a regular I/O Queue it described in the NVMe specification, may be used to submit IO operations by host, completions may be notified to host by firing interrupt on a host side (when not disabled)
Drive <-> Drive IO queues: This type of queues might not be described in the NVMe standard. Drive A (e.g. the first storage device 100) may submit a (further) request to Drive B (e.g. the second storage device 200) in the same way as host submits I/O i.e. to fill target drive's SQE (submission queue) and ring doorbell (which may be mapped to host system physical address space; this address may be known to initiator drive). Completion notification may be implemented using doorbell on initiator drive side (e.g. doorbell of the first storage device)—target drive (e.g. the second storage device) may ring the doorbell when I/O handling is completed (when it is to fire interrupt in case of standard Host <-> Drive IO queue)

At least some examples may provide new Admin Queue commands for SSDs with RAID processing engines to configure Drive to Drive communication:
Assign host memory buffer (meant as a list of pages) to be owned by a drive. This memory may be used by a drive to allocate PRP pages for data buffer when it is to initiate peer to peer read or Write I/O against another drive.
Create Target side Submission/Completion Queue Pair—this command may assign host memory addresses of SQ and CQ to drive physical queue. It may also pass the initiator drive doorbell address (e.g. of the first storage device 100) in host system physical address space.
Pass Submission/Completion Queue Pair addresses to Initiator—this command may assign host memory addresses of target drive (e.g. the second storage device 200) SQ and CQ to Initiator drive (e.g. the first storage device 100) RAID Processor Master. It may also pass target drive doorbell address in host system physical address space.

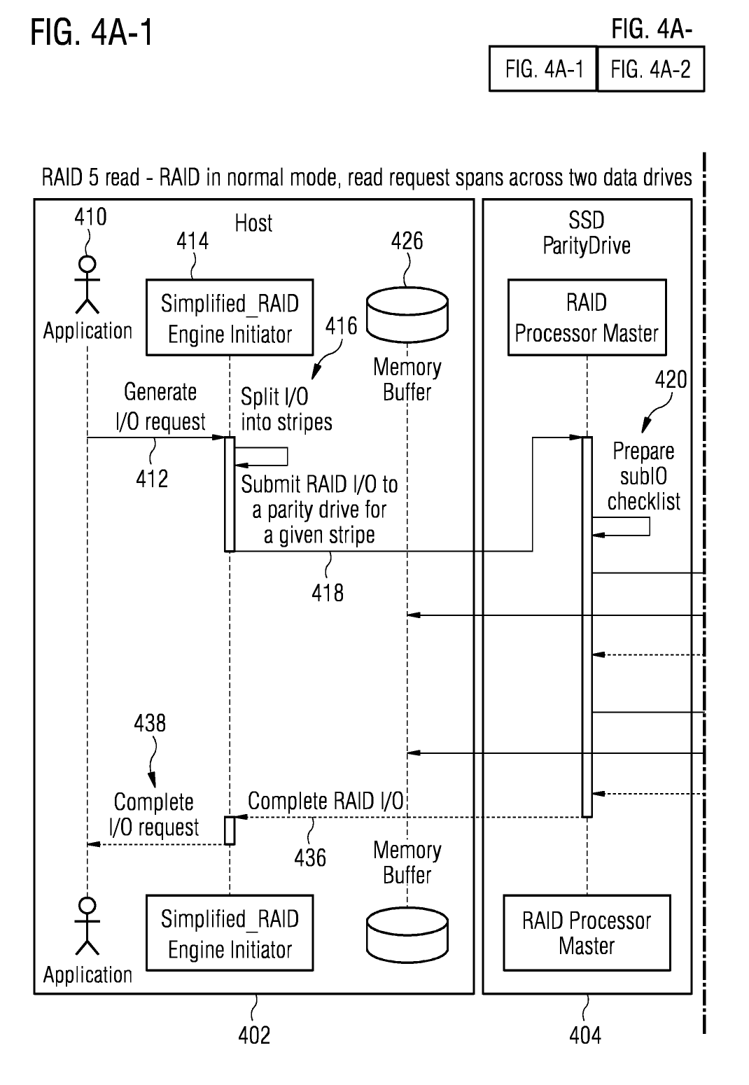

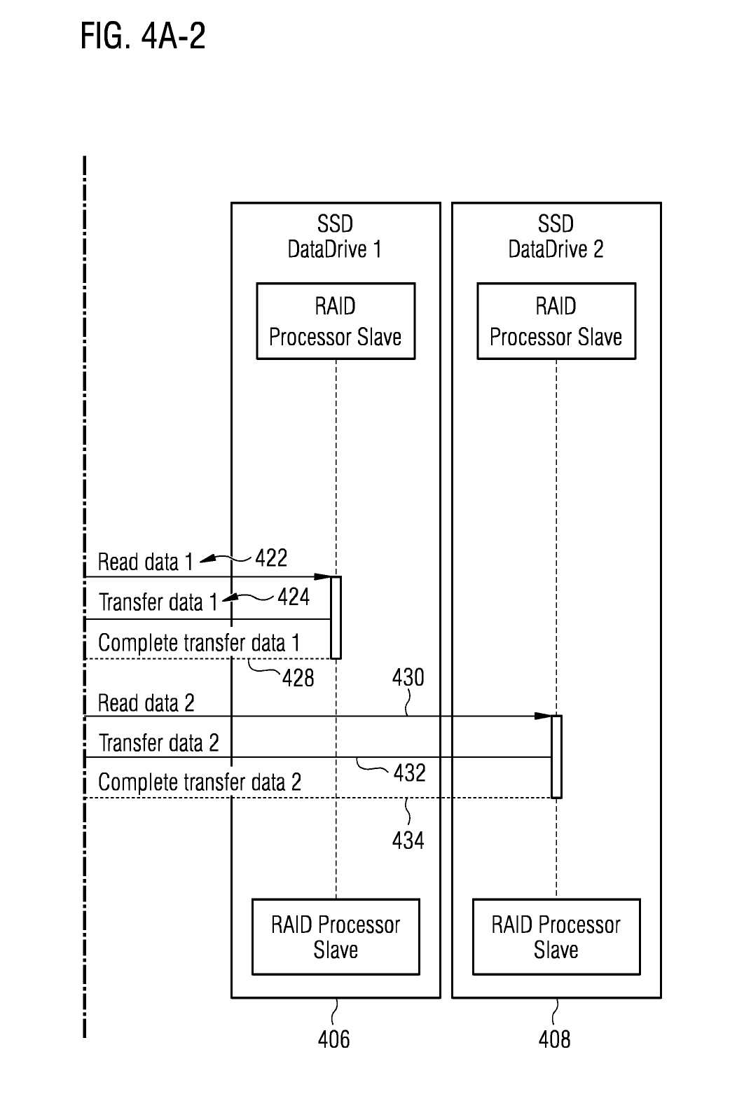

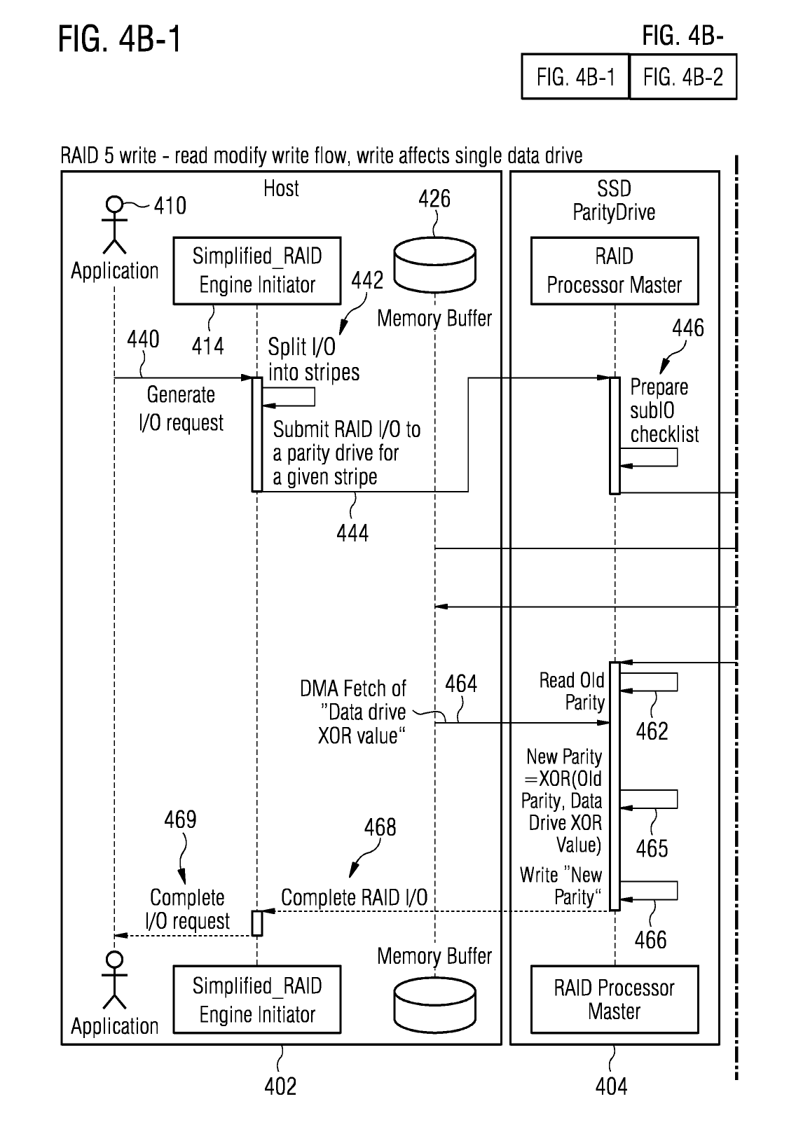

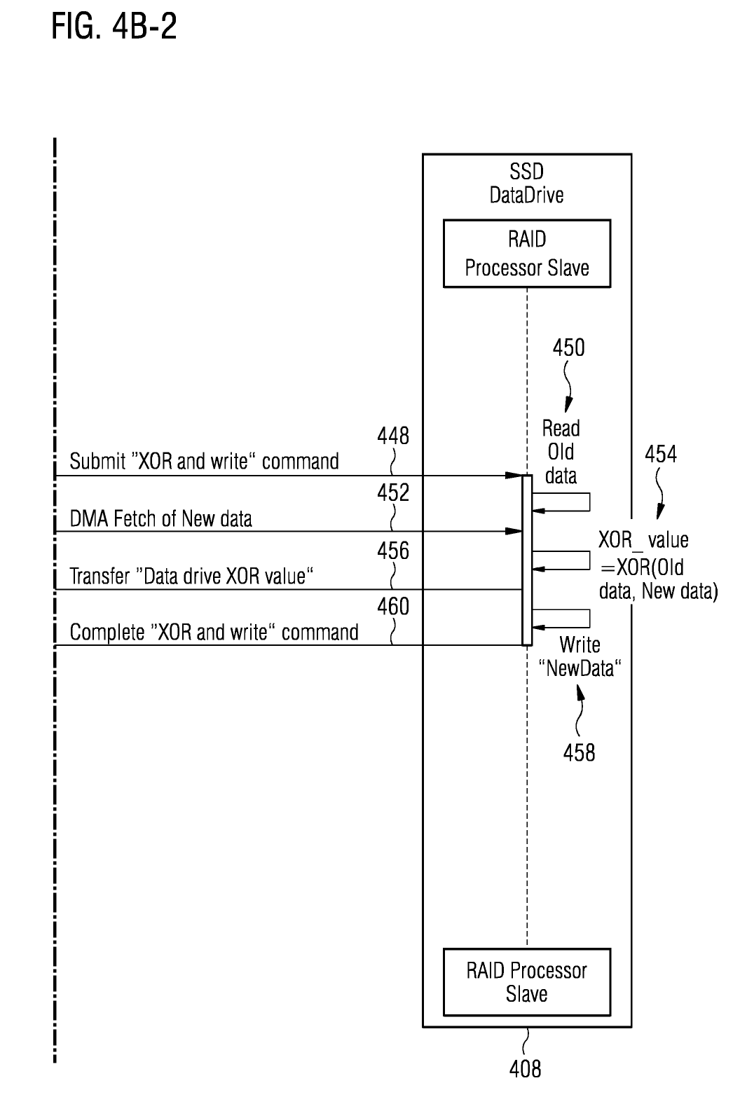

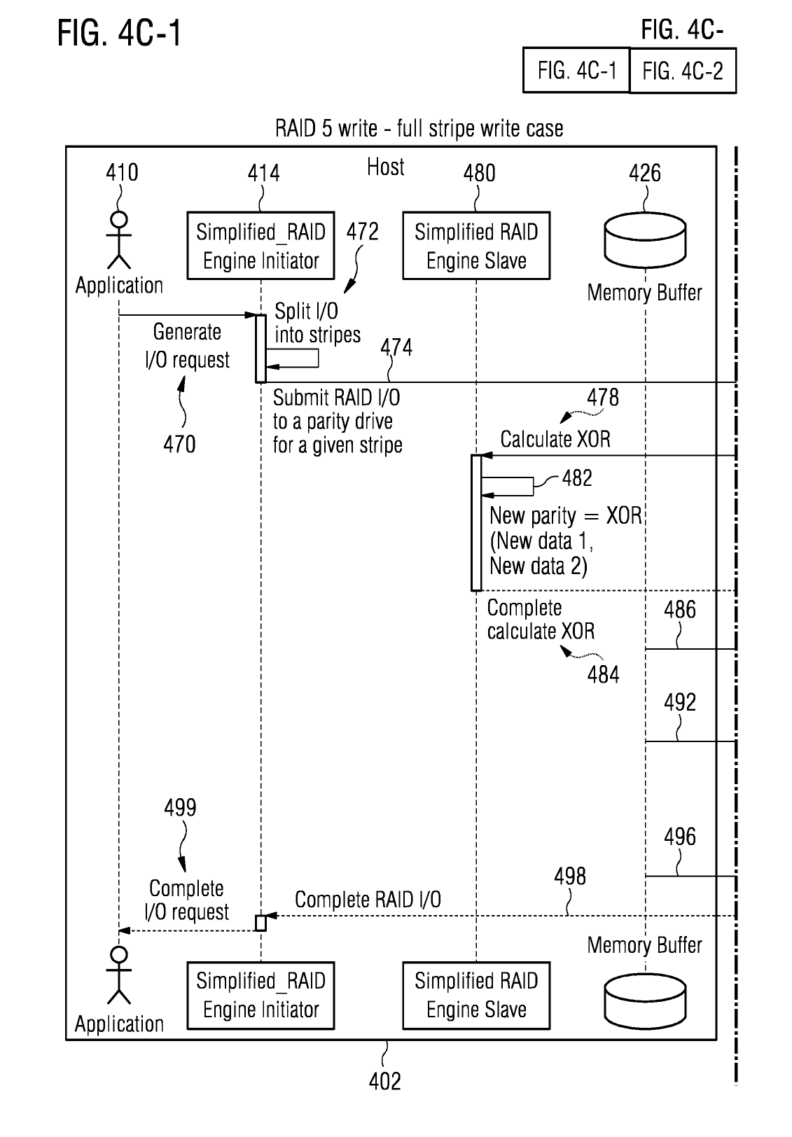

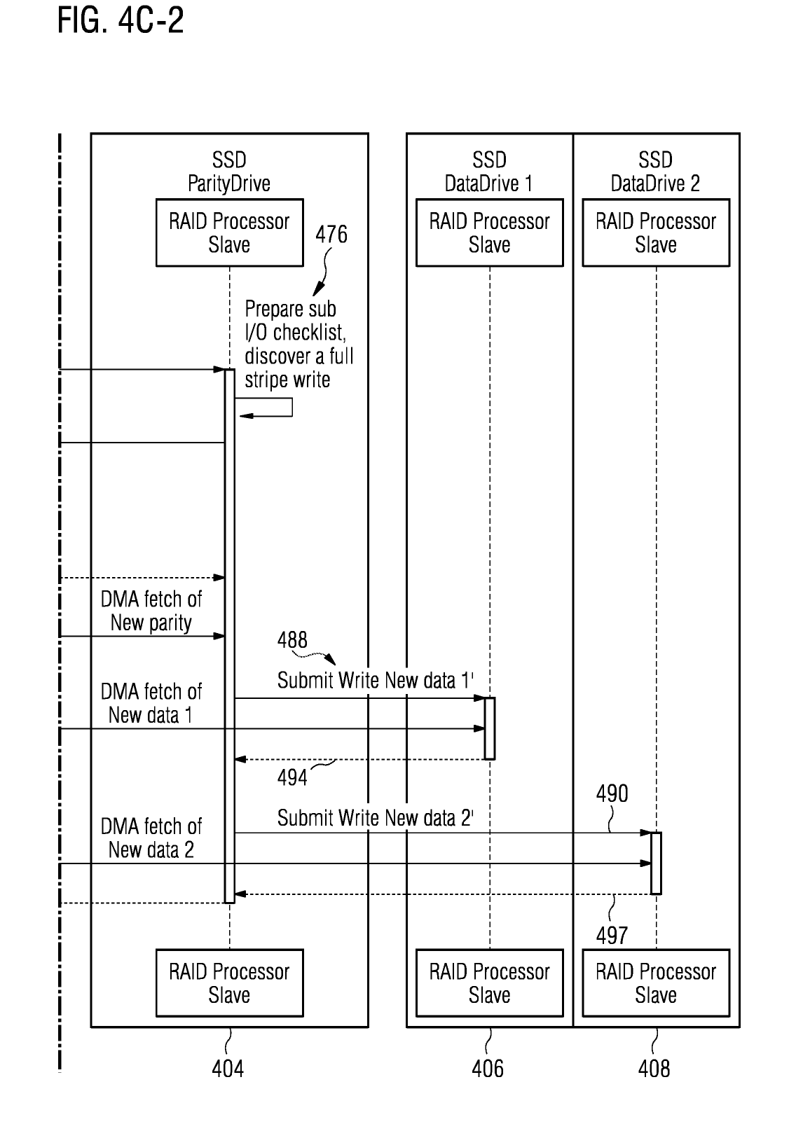

FIG. 4a shows a flow chart of a flow for a RAIDS read operation according to an example. In FIG. 4a, the volume may be in a normal state and the operation may require to span I/O across two data drives. FIG. 4a shows a host 402 (e.g. the computer system host 310), an SSD with RAID processing engine parity drive 404 (e.g. the first storage device 100) as RAID processor master, and two SSDs with RAID processing engines data drives 406; 408 (e.g. two instances of the second storage device 200) as RAID processor slaves.

If an application 410 of the host 402 generates an I/O request 412, the request is transmitted to a simplified RAID Engine Initiator 414, which may be configured to split 416 the I/O into (RAID) stripes and submit 418 the RAID I/O (request) to a parity drive for a given stripe, e.g. the parity drive 404. The parity drive 404 may be configured to prepare 420 a subIO checklist, and issue 422 a further request to read data to the data drive 406. The data drive 406 may be configured to transfer 424 data to a memory buffer 426 of the host 402, and to notify 428 the parity drive 404 that the data transfer is complete. The parity drive 404 may be further configured to issue 430 a further request to data drive 408, which may be configured to transfer 432 data to the memory buffer 426 and to notify 428 the parity drive 404 that the data transfer is complete. Once the completion notifications have been received from the data drives 406; 408, the parity drive 404 may be configured to notify 430 the Simplified RAID Engine Initiator 414, which may be configured to notify 432 the application 410 of the completion of the I/O request 412.

In at least some examples, the stripe owner (e.g. the storage device 100) might not be involved in data plane transfers as a proxy if not necessary (i.e. when data doesn't need to be processed e.g. recovered). It may be configured to create requests for member disks containing PRP/SGL (Physical Region Page/Scatter Gather List) lists based on RAID I/O PRP/SGL list pointing to host memory buffer, which may allow to perform member disks DMA (Direct Memory Access) transfers directly to proper host memory location. PRP stands for Physical Region Page, SGL stands for Scatter Gather List. These are two ways on how NVMe standard defines a format of host memory, where data is transferred from the drive (on read) or to the drive (on write). NVMe read and write commands use this format to describe where, in the host memory, data is stored to be written to the drive, or where is a placeholder for data to be read from the drive.

FIG. 4b shows a flow chart of a RAIDS write with a read-modify write flow according to an example. FIG. 4b shows a host 402 (e.g. the computer system host 310), an SSD with RAID processing engine parity drive 404 (e.g. the first storage device 100) as RAID processor master, and an SSD with RAID processing engine data drive 408 (e.g. the second storage device 200) as RAID processor slave.

If an application 410 of the host 402 generates an I/O request 440, the request is transmitted to a simplified RAID Engine Initiator 414, which may be configured to split 442 the I/O into (RAID) stripes and submit 444 the RAID I/O (request) to a parity drive for a given stripe, e.g. the parity drive 404. The parity drive 404 may be configured to prepare 446 a subIO checklist, and submit 448 an “XOR and write” (Exclusive Or and write) command to the data drive 408. The data drive 408 may be configured to read 450 the old data, fetch 452 new data from a memory buffer 426 of the host 402 (using DMA), calculate 454 an XOR value from the old data and the new data, transfer 456 the XOR value to the memory buffer 426, write 458 the new data and notify 460 the parity drive 404 that the “XOR and write” command is complete. The parity drive 404 may be configured to read 462 the old parity, fetch 464 the XOR value from the memory buffer 426, calculate an XOR value of the old parity and the XOR value to determine a new parity, to write 466 the new parity, and to notify 468 the Simplified RAID Engine Initiator, that the Raid I/O transaction is complete. The Simplified RAID Engine Initiator may be configured to notify 469 the application, that the I/O request 440 is complete.

FIG. 4c shows a flow chart of a flow for a RAID 5 full stripe write according to an example. In FIG. 4c, the volume may be in a normal state and the operation may require to span I/O across two data drives. FIG. 4c shows a host 402 (e.g. the computer system host 310), an SSD with RAID processing engine parity drive 404 (e.g. the first storage device 100) as RAID processor master, and two SSDs with RAID processing engines data drives 406; 408 (e.g. two instances of the second storage device 200) as RAID processor slaves.

If an application 410 of the host 402 generates an I/O request 470, the request is transmitted to a simplified RAID Engine Initiator 414, which may be configured to split 472 the I/O into (RAID) stripes and submit 474 the RAID I/O (request) to a parity drive for a given stripe, e.g. the parity drive 404. The parity drive 404 may be configured to prepare 476 a subIO checklist and discover a full stripe write, and to instruct 478 a Simplified RAID Engine Slave 480 on the host 402 to calculate the XOR. The Simplified RAID Engine Slave may be configured to calculate 482 a new parity by XOR'ing new data blocks new data 1 and new data 2 (e.g. and to write it to a memory buffer 426 of the host 402), and to notify 484 the parity drive 404 upon completion. The parity drive 404 may be configured to fetch 486 the new parity from the memory buffer using DMA, and submit 488 an instruction to data drive 406 to write data block new data 1 and submit 490 an instruction to parity drive 408 to write data block new data 2. Data drive 406 may be configured to fetch 492 new data 1 from the memory buffer 426 using DMA (and to write it to storage) and to notify 494 parity drive 404 after completion. Data drive 408 may be configured to fetch 496 new data 1 from the memory buffer 426 using DMA (and to write it to storage) and to notify 497 parity drive 404 after completion. The parity drive 404 may be configured to notify 498 the Simplified RAID Engine Initiator 414, which may be configured to notify 499 the Application 410 after I/O request 470 is complete.

There may be cases (like a full-stripe write), that an improved algorithm may calculate parity on the host side (e.g. all the data is already there—no need for reading any data from the drives), e.g. on the computer system host 310. The SSD with RAID processing engine drive (as an initiator, e.g. the first storage device 100) may be configured to discover such situations and to delegate this work to the host (e.g. parity calculation).

Several possible errors may be handled by examples. In case of a stripe owner failure while processing the RAID logic, the host (e.g. the computer system host 310) may be configured to handle the error. If the host does not get a response from the stripe owner in particular time, the RAID volume may become degraded and the host may become a stripe owner of the stripes previously owned by the failed drive.

In case of slave drive failure, e.g. when a stripe owner (e.g. the first storage device 100) does not get a response from the slave drive in particular time, it may be configured to switch to a degraded mode, process the I/O using a degraded path and inform the host about the situation. In order to rebuild a degraded RAID volume, a spare drive can be inserted by the user and marked as a RAID rebuild target. The rebuild process may be performed by the SSDs with RAID processing engines drives (each stripe by its owner), including the new spare SSD with RAID processing engine.

At least some examples may be applicable to NAND based or 3DXP (3D Crosspoint) based NVMe drives. NVMe drives with embedded RAID logic can be coupled with Software RAID approaches, like RSTe and provide a value add for the customers, if they use drives configured to provide hardware raid.

A first example provides a computer system 300 comprising a first storage device 100 and a second storage device 200, wherein a storage region is distributed across the first storage device 100 and the second storage device 200. The computer system 300 further comprises a computer system host 310 and a communication infrastructure 320 configured to connect the first storage device 100, the second storage device 200 and the computer system host. The computer system host 310 is configured to transmit a request related to the storage region to the first storage device 100 via the communication infrastructure 320, and the first storage device 100 is configured to issue a further request to the second storage device 200 via the communication infrastructure 320 to execute the request.

In example 2, the first storage device 100 is configured to issue the further request to the second storage device 200 if the request is related to a portion of the storage region stored on the second storage device 200.

In example 3, the first storage device 100 is configured to execute the request if the request is related to a portion of the storage region stored on the first storage device.

In example 4, the further request is based on the request. Alternatively or additionally, the issuing of the further request to the second storage device 200 may comprise determining whether the request is related to a portion of the storage region stored on the second storage device 200, transforming the request into the further request for the second storage device 200, and transmitting the further request to the second storage device 200 using the communication infrastructure 320.

In example 5, the further request is a forwarded version of the request. Alternatively or additionally, the issuing of the further request to the second storage device 200 may comprise determining whether the request is related to a portion of the storage region stored on the second storage device 200 and forwarding the request as further request to the second storage device 200 using the communication infrastructure 320.

In example 6, a portion of the storage region stored on the first storage device 100 comprises parity information, and wherein a portion of the storage region stored on the second storage device 200 comprises non-parity data.

In example 7, the storage region is a stripe of a Redundant Array of Independent Disks, RAID. Alternatively or additionally, the first storage device 100 may be a processor master of the RAID for the storage region. Alternatively or additionally, the second storage device 200 may be a processor slave of the RAID for the storage region.

In example 8, the second storage device 200 is configured to notify the first storage device 100 after completing the further request. Alternatively or additionally, the first storage device 100 may be configured to notify the computer system host 310 after the request is complete.

In example 9, the second storage device 200 is configured to read data related to the further request from a memory of the computer system host 310. Alternatively or additionally, the second storage device 200 may be configured to write data related to the further request to a memory of the computer system host 310.

In example 10, the first storage device 100 is configured to read parity information related to the request from a memory of the computer system host 310. Alternatively or additionally, the computer system host 310 may be configured to determine new parity information based on the request and to provide the new parity information to the first storage device 100.

In example 11, the second storage device 200 is configured to determine new parity information related to the further request.

In example 12, the second storage device 200 is configured to write the new parity information to a memory of the computer system host 310, and the first storage device 100 is configured to read the new parity information from the memory of the computer system host 310.

In example 13, the first storage device 100 comprises a transmission queue for transmissions to the second storage device 200.

In example 14, a second storage region is distributed across the first storage device 100 and the second storage device 200, and the computer system host 310 is configured to transmit a second request related to the second storage region to the second storage device 200 via the communication infrastructure 320, and the second storage device 200 is configured to issue a second further request to the first storage device 100 via the communication infrastructure 320 to execute the second request.

In example 15, the storage region and the second storage region are stripes of a volume of a Redundant Array of Independent Disks, RAID. Alternatively or additionally, the first storage device 100 is a processor slave of the RAID for the second storage region. Alternatively or additionally, the second storage device 200 is a processor master of the RAID for the second storage region.

In example 16, the first storage device 100 comprises a first storage module and the second storage device 200 comprises a second storage module, wherein the storage region is distributed across the first storage module and the second storage module.

In example 17, the request and/or the further request comprise at least one element of the group of a request to write data to the storage region, a request to read data from the storage region and a request to update data within the storage region.

In example 18, the first storage device 100 and/or the second storage device 200 are configured to communicate via a non-volatile memory express communication protocol.

In example 19, the communication infrastructure is a Peripheral Component Interconnect express, PCIe, communication infrastructure. Alternatively or additionally, the communication infrastructure may be a point to point communication infrastructure. Alternatively or additionally, the first storage device 100 may be configured to issue the further request to the second storage device 200 using a peer-to-peer connection between the first storage device 100 and the second storage device 200. Alternatively or additionally, the first storage device 100 may be configured to issue the further request to the second storage device 200 without involving the computer system host 310 and/or without involving a central processing unit of the computer system.

Example 20 provides a controller 10 for a first storage device 100 of a computer system 300. The controller 10 comprises an interface 12 configured to receive, via a communication infrastructure 320, a request related to a storage region distributed across the first storage device 100 and a second storage device 200 from a computer system host 310. The controller further comprises a control module 14 configured to issue a further request to the second storage device 200 via the communication infrastructure 320 to execute the request.

In example 21, the control module 14 is configured to issue the further request to the second storage device 200 if the request is related to a portion of the storage region stored on the second storage device 200.

In example 22, the control module 14 is configured to execute the request if the request is related to a portion of the storage region stored on the first storage device.

In example 23, the control module 14 is configured to notify the computer system host 310 after the request is complete.

In example 24, the control module 14 is configured to read parity information related to the request from a memory of the computer system host 310.

In example 25, control module 14 is configured to read new parity information determined by the second storage device 200 from a memory of the computer system host 310.

In example 26, the controller 10 comprises a transmission queue for transmissions to the second storage device 200.

In example 27, the control module 14 is configured to communicate via a non-volatile memory express communication protocol with the second storage device 200. Alternatively or additionally, the control module 14 may be configured to issue the further request to the second storage device 200 using a peer-to-peer connection between the first storage device 100 and the second storage device 200. Alternatively or additionally, the control module 14 may be configured to issue the further request to the second storage device 200 without involving the computer system host 310 and/or without involving a central processing unit of the computer system.

Example 28 provides a controller 20 for a second storage device 200 of a computer system 300. The controller 20 comprises an interface 22 configured to receive a request related to a storage region distributed across a first storage device and the second storage device from the first storage device 100 via a communication infrastructure 320. The controller 20 further comprises a control module 24 configured to execute the request related to the storage region on a portion of the storage region stored on the second storage device 200.

In example 29, the control module 24 is configured to notify the first storage device 100 after completing the further request.

In example 30, the control module 24 is configured to read data related to the further request from a memory of the computer system host 310. Alternatively or additionally, the control module 24 may be configured to write data related to the further request to a memory of the computer system host 310.

In example 31, the control module 24 is configured to determine new parity information related to the further request.

In example 32, the control module 24 is configured to write the new parity information to a memory of the computer system host 310.

In example 33, the control module 24 is configured to communicate with the first storage device 100 using a non-volatile memory express communication protocol.

In example 33, a second storage region is distributed across the first storage device 100 and the second storage device 200, and wherein the control module 24 is configured to receive a second request related to the second storage region from the computer system host via the communication infrastructure 320, and the control module 24 is configured to issue a second further request to the first storage device 100 via the communication infrastructure 320 to execute the second request.

Example 34 provides a storage device 100; 200 comprising the controller 10 according to one of the examples 20 to 27 and/or the controller 20 according to one of the examples 28 to 33.

Example 35 provides a computer system host 310 for a computer system 300. The computer system host 310 comprises at least one interface 312 configured to communicate via a communication infrastructure 320. The computer system host 310 further comprises a control module 314 configured to transmit a request related to a storage region distributed across a first storage device 100 and a second storage device 200 to the first storage device 100 via the communication infrastructure 320 if the request is related to a portion of the storage region stored on the second storage device 200.

In example 37, the control module 314 is configured to determine new parity information based on the request and to provide the new parity information to the first storage device 100.

Example 38 provides a distributed redundant array of independent disks comprising a first storage device 100 and a second storage device 200. A storage region is distributed across the first storage device 100 and the second storage device 200. The first storage device 100 is a processor master for the storage region and wherein the second storage device 200 is a processor slave for the storage region.

Example 39 provides a method for a computer system 300, the computer system 300 comprising a first storage device 100, a second storage device 200 and a communication infrastructure 320, wherein a storage region is distributed across the first storage device 100 and the second storage device 200. The method comprises transmitting 340 a request related to the storage region to the first storage device 100 via the communication infrastructure 320. The method further comprises the first storage device 100 issuing 120 a further request to the second storage device 200 via the communication infrastructure 320 to execute the request.

In example 40, the further request is issued by the first storage device 100 to the second storage device 200 if the request is related to a portion of the storage region stored on the second storage device 200.

In example 41, the method further comprises by the first storage device 100 executing the request if the request is related to a portion of the storage region stored on the first storage device 100.

In example 42, the further request is based on the request. Alternatively or additionally, the issuing of the further request to the second storage device 200 may comprise determining whether the request is related to a portion of the storage region stored on the second storage device 200, transforming the request into the further request for the second storage device 200, and transmitting the further request to the second storage device 200 using the communication infrastructure 320.

In example 43, the further request is a forwarded version of the request. Alternatively or additionally, the issuing of the further request to the second storage device 200 may comprise determining whether the request is related to a portion of the storage region stored on the second storage device 200 and forwarding the request as further request to the second storage device 200 using the communication infrastructure 320.

In example 44, the method may further comprise the second storage device 200 notifying the first storage device 100 after completing the further request. Alternatively or additionally, the method may further comprise the first storage device 100 notifying the computer system host 310 after the request is complete.

In example 45, the method may further comprise the second storage device 200 reading data related to the further request from a memory of the computer system host 310. Alternatively or additionally, the method may further comprise the second storage device 200 writing data related to the further request to a memory of the computer system host 310.

In example 46, the method may further comprise the first storage device 100 reading parity information related to the request from a memory of the computer system host 310, Alternatively or additionally, the method may further comprise the computer system host 310 determining new parity information based on the request and to provide the new parity information to the first storage device 100.

In example 47, the method further comprises the second storage device 200 determining new parity information related to the further request.

In example 48, the new parity information is written by the second storage device 200 to a memory of the computer system host 310, and further comprising the first storage device 100 reading the new parity information from the memory of the computer system host 310.

In example 49, a second storage region is distributed across the first storage device 100 and the second storage device 200, the method further comprising transmitting a second request related to the second storage region to the second storage device 200 via the communication infrastructure 320, and the second storage device 200 issuing a second further request to the first storage device 100 via the communication infrastructure 320 to execute the second request.

In example 50, the first storage device 100 and/or the second storage device 200 are communicating via a non-volatile memory express communication protocol.

In example 51, the method may further comprise the first storage device 100 issuing the further request to the second storage device 200 using a peer-to-peer connection between the first storage device 100 and the second storage device 200. Alternatively or additionally, the method may further comprise the first storage device 100 is issuing the further request to the second storage device 200 without involving the computer system host 310 and/or without involving a central processing unit of the computer system.

Example 52 provides a method for a first storage device 100 of a computer system 300. The method comprises receiving 110 via a communication infrastructure 320, a request related to a storage region distributed across the first storage device 100 and a second storage device 200 from a computer system host 310. The method further comprises issuing 120 a further request to the second storage device 200 via the communication infrastructure 320 to execute the request.

In example 53, the further request is issued to the second storage device 200 if the request is related to a portion of the storage region stored on the second storage device 200.

In example 54, the method further comprises executing the request if the request is related to a portion of the storage region stored on the first storage device.

In example 55, the method further comprises notifying the computer system host 310 after the request is complete.

In example 56, the method further comprises reading parity information related to the request from a memory of the computer system host 310.

In example 57, the method may further comprise reading new parity information determined by the second storage device 200 from a memory of the computer system host 310.

In example 58, the further request is issued using a transmission queue for transmissions to the second storage device 200.

In example 59, the first storage device 100 communicates via a non-volatile memory express communication protocol with the second storage device 200. Alternatively or additionally, he further request is issued to the second storage device 200 using a peer-to-peer connection between the first storage device 100 and the second storage device 200. Alternatively or additionally, the further request is issued to the second storage device 200 without involving the computer system host 310 and/or without involving a central processing unit of the computer system.

Example 60 provides a method for a second storage device 200 of a computer system 300. The method comprises receiving 210 a request related to a storage region distributed across a first storage device and the second storage device from the first storage device 100 via a communication infrastructure 320. The method further comprises executing 220 the request related to the storage region on a portion of the storage region stored on the second storage device 200.

In example 61, the method further comprises notifying the first storage device 100 after completing the further request.

In example 62, the method may further comprise reading data related to the further request from a memory of the computer system host 310. Alternatively or additionally, the method may further comprise writing data related to the further request to a memory of the computer system host 310.

In example 63, the method further comprises determining new parity information related to the further request.

In example 64, the method further comprises writing the new parity information to a memory of the computer system host 310.

In example 65, the second storage device 200 communicates with the first storage device 100 using a non-volatile memory express communication protocol.

In example 66 a second storage region is distributed across the first storage device 100 and the second storage device 200, and the method further comprises receiving a second request related to the second storage region from the computer system host via the communication infrastructure 320, the method further comprises issuing a second further request to the first storage device 100 via the communication infrastructure 320 to execute the second request.

Example 67 provides a method for a computer system host 310 for a computer system 300. The method comprises communicating 330 via a communication infrastructure 320. The method further comprises transmitting 340 a request related to a storage region distributed across a first storage device 100 and a second storage device 200 to the first storage device 100 via the communication infrastructure 320 if the request is related to a portion of the storage region stored on the second storage device 200.

In example 68, the method further comprises determining new parity information based on the request and providing the new parity information to the first storage device 100.

Example 69 provides machine readable storage medium including program code, when executed, to cause a machine to perform the method of one of the examples 39 to 68.

Example 70 provides a computer program having a program code for performing the method of at least one of the examples 39 to 68, when the computer program is executed on a computer, a processor, or a programmable hardware component.

Example 71 provides a machine readable storage including machine readable instructions, when executed, to implement a method or realize an apparatus as claimed in any pending claim.

Example 72 provides a computer system 300 comprising a first storage means 100 and a second storage means 200, wherein a storage region is distributed across the first storage means 100 and the second storage means 200. The computer system 300 of example 72 further comprises a computer system host apparatus 310 and a communication means 320 configured to connect the first storage means 100, the second storage means 200 and the computer system host apparatus. The computer system host apparatus 310 is configured for transmitting a request related to the storage region to the first storage means 100 via the communication means 320. The first storage means 100 is configured for issuing a further request to the second storage means 200 via the communication means 320 to execute the request.

In example 73, the first storage means 100 is configured for issuing the further request to the second storage means 200 if the request is related to a portion of the storage region stored on the second storage means 200.

In example 74, the first storage means 100 is configured for executing the request if the request is related to a portion of the storage region stored on the first storage means.

In example 75, the further request is based on the request. Alternatively or additionally, the issuing of the further request to the second storage means 200 may comprise determining whether the request is related to a portion of the storage region stored on the second storage means 200, transforming the request into the further request for the second storage means 200, and transmitting the further request to the second storage means 200 using the communication means 320.

In example 76, the further request is a forwarded version of the request. Alternatively or additionally, the issuing of the further request to the second storage means 200 may comprise determining whether the request is related to a portion of the storage region stored on the second storage means 200 and forwarding the request as further request to the second storage means 200 using the communication means 320.

In example 77, a portion of the storage region stored on the first storage means 100 comprises parity information, and wherein a portion of the storage region stored on the second storage means 200 comprises non-parity data.

In example 78, the storage region is a stripe of a Redundant Array of Independent Disks, RAID. Alternatively or additionally, the first storage means 100 may be a processor master of the RAID for the storage region. Alternatively or additionally, the second storage means 200 may be a processor slave of the RAID for the storage region.

In example 79, the second storage means 200 may be configured for notifying the first storage means 100 after completing the further request. Alternatively or additionally, the first storage means 100 may be configured for notifying the computer system host apparatus 310 after the request is complete.

In example 80, the second storage means 200 may be configured for reading data related to the further request from a memory of the computer system host apparatus 310. Alternatively or additionally, the second storage means 200 may be configured for writing data related to the further request to a memory of the computer system host apparatus 310.

In example 81, the first storage means 100 may be configured for reading parity information related to the request from a memory of the computer system host apparatus 310. Alternatively or additionally, the computer system host apparatus 310 may be configured for determining new parity information based on the request and for providing the new parity information to the first storage means 100.

In example 82, the second storage means 200 is configured for determining new parity information related to the further request.

In example 83, the second storage means 200 is configured for writing the new parity information to a memory of the computer system host apparatus 310, and the first storage means 100 is configured for reading the new parity information from the memory of the computer system host apparatus 310.

In example 84, the first storage means 100 comprises a transmission queue for transmissions to the second storage means 200.

In example 85, a second storage region is distributed across the first storage means 100 and the second storage means 200, and the computer system host apparatus 310 is configured for transmitting a second request related to the second storage region to the second storage means 200 via the communication means 320, and the second storage means 200 is configured for issuing a second further request to the first storage means 100 via the communication means 320 to execute the second request.

In example 86, the storage region and the second storage region may be stripes of a volume of a Redundant Array of Independent Disks, RAID. Alternatively or additionally, the first storage means 100 may be a processor slave of the RAID for the second storage region. Alternatively or additionally, the second storage means 200 may be a processor master of the RAID for the second storage region.

In example 87, the first storage means 100 comprises a first storage module and the second storage means 200 comprises a second storage module, wherein the storage region is distributed across the first storage module and the second storage module.

In example 88, the request and/or the further request comprise at least one element of the group of a request to write data to the storage region, a request to read data from the storage region and a request to update data within the storage region.

In example 89, the first storage means 100 and/or the second storage means 200 are configured to communicate via a non-volatile memory express communication protocol.

In example 90, the communication means may be a Peripheral Component Interconnect express, PCIe, communication means. The communication means may be a point to point communication means. The first storage means 100 may be configured for issuing the further request to the second storage means 200 using a peer-to-peer connection between the first storage means 100 and the second storage means 200. The first storage means 100 may be configured for issuing the further request to the second storage means 200 without involving the computer system host apparatus 310 and/or without involving a central processing unit of the computer system.

Example 91 provides an apparatus 10 for a first storage means 100 of a computer system 300. The apparatus 10 comprises a means for communicating 12 configured for receiving, via a communication means 320, a request related to a storage region distributed across the first storage means 100 and a second storage means 200 from a computer system host apparatus 310. The apparatus 10 further comprises a means for controlling 14 configured for issuing a further request to the second storage means 200 via the communication means 320 to execute the request.

In example 92, the means for controlling 14 is configured for issuing the further request to the second storage means 200 if the request is related to a portion of the storage region stored on the second storage means 200.

In example 93, the means for controlling 14 is configured for executing the request if the request is related to a portion of the storage region stored on the first storage means.

In example 94, the means for controlling 14 is configured for notifying the computer system host apparatus 310 after the request is complete.

In example 95, the control module 14 is configured for reading parity information related to the request from a memory of the computer system host apparatus 310.

In example 96, the means for controlling 14 is configured for reading new parity information determined by the second storage means 200 from a memory of the computer system host apparatus 310.

In example 97, the controller 10 comprises a transmission queue for transmissions to the second storage means 200.

In example 98, the means for controlling 14 may be configured for communicating via a nonvolatile memory express communication protocol with the second storage means 200. The means for controlling 14 may be configured for issuing the further request to the second storage means 200 using a peer-to-peer connection between the first storage means 100 and the second storage means 200. The means for controlling 14 may be configured for issuing the further request to the second storage means 200 without involving the computer system host apparatus 310 and/or without involving a central processing unit of the computer system.

Example 99 provides an apparatus 20 for a second storage means 200 of a computer system 300. The apparatus 20 comprises a means for communicating 22 configured for receiving a request related to a storage region distributed across a first storage means and the second storage means from the first storage means 100 via a communication means 320. The apparatus 20 further comprises a means for controlling 24 configured for executing the request related to the storage region on a portion of the storage region stored on the second storage means 200.

In example 100, the means for controlling 24 is configured for notifying the first storage means 100 after completing the further request.

In example 101, the means for controlling 24 may be configured to read data related to the further request from a memory of the computer system host apparatus 310, and/or the means for controlling 24 may be configured for writing data related to the further request to a memory of the computer system host apparatus 310.

In example 102, the means for controlling 24 is configured for determining new parity information related to the further request.

In example 103, the means for controlling 24 is configured for writing the new parity information to a memory of the computer system host apparatus 310.

In example 104, the means for controlling 24 is configured for communicating with the first storage means 100 using a non-volatile memory express communication protocol.

In example 105, a second storage region is distributed across the first storage means 100 and the second storage means 200, and the means for controlling 24 is configured for receiving a second request related to the second storage region from the computer system host apparatus via the communication means 320, and the means for controlling 24 is configured for issuing a second further request to the first storage means 100 via the communication means 320 to execute the second request.

Example 106 provides a storage means 100; 200 comprising the apparatus 10 according to one of the examples 91 to 98 and/or the apparatus 20 according to one of the examples 99 to 105.

Example 107 provides a computer system host apparatus 310 for a computer system 300. The computer system host apparatus 310 comprises at least one means for communicating 312 configured for communicating via a communication means 320. The computer system host apparatus 310 comprises a means for controlling 314 configured to transmit a request related to a storage region distributed across a first storage means 100 and a second storage means 200 to the first storage means 100 via the communication means 320 if the request is related to a portion of the storage region stored on the second storage means 200.

In example 108, the means for controlling 314 is configured to determine new parity information based on the request and to provide the new parity information to the first storage means 100.

Example 109 provides a distributed redundant array of independent disks comprising a first storage means 100 and a second storage means 200. A storage region is distributed across the first storage means 100 and the second storage means 200 and the first storage means 100 is a processor master for the storage region and the second storage means 200 is a processor slave for the storage region.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays (MPLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A computer system comprising:
a first storage device and a second storage device, wherein a storage region is distributed across the first storage device and the second storage device;
a computer system host; and
a communication infrastructure configured to connect the first storage device, the second storage device and the computer system host,
wherein the computer system host is configured to transmit a request related to the storage region to the first storage device via the communication infrastructure, and wherein the first storage device is configured to issue a further request to the second storage device via the communication infrastructure to execute the request.

2. The computer system according to claim 1, wherein the first storage device is configured to issue the further request to the second storage device if the request is related to a portion of the storage region stored on the second storage device.

3. The computer system according to claim 2, wherein the first storage device is configured to execute the request if the request is related to a portion of the storage region stored on the first storage device.

4. The computer system according to claim 1,
wherein the further request is based on the request,
and/or wherein the issuing of the further request to the second storage device comprises determining whether the request is related to a portion of the storage region stored on the second storage device, transforming the request into the further request for the second storage device, and transmitting the further request to the second storage device using the communication infrastructure.

5. The computer system according to claim 1,
wherein the further request is a forwarded version of the request,
and/or wherein the issuing of the further request to the second storage device comprises determining whether the request is related to a portion of the storage region stored on the second storage device and forwarding the request as further request to the second storage device using the communication infrastructure.

6. The computer system according to claim 1, wherein a portion of the storage region stored on the first storage device comprises parity information, and wherein a portion of the storage region stored on the second storage device comprises non-parity data.

7. The computer system according to claim 1, wherein the storage region is a stripe of a Redundant Array of Independent Disks (RAID),
and/or wherein the first storage device is a processor master of the RAID for the storage region,
and/or wherein the second storage device is a processor slave of the RAID for the storage region.

8. The computer system according to claim 1, wherein the second storage device is configured to notify the first storage device after completing the further request, and/or wherein the first storage device is configured to notify the computer system host after the request is complete.

9. The computer system according to claim 1, wherein the second storage device is configured to read data related to the further request from a memory of the computer system host,
and/or wherein the second storage device is configured to write data related to the further request to a memory of the computer system host.

10. The computer system according to claim 1,
wherein the first storage device is configured to read parity information related to the request from a memory of the computer system host,
and/or wherein the computer system host is configured to determine new parity information based on the request and to provide the new parity information to the first storage device.

11. The computer system according to claim 1, wherein the second storage device is configured to determine new parity information related to the further request.

12. The computer system according to claim 11, wherein the second storage device is configured to write the new parity information to a memory of the computer system host, and wherein the first storage device is configured to read the new parity information from the memory of the computer system host.

13. The computer system according to claim 1, wherein the first storage device comprises a transmission queue for transmissions to the second storage device.

14. The computer system according to claim 1, wherein a second storage region is distributed across the first storage device and the second storage device, and wherein the computer system host is configured to transmit a second request related to the second storage region to the second storage device via the communication infrastructure, and
wherein the second storage device is configured to issue a second further request to the first storage device via the communication infrastructure to execute the second request.

15. The computer system according to claim 14, wherein the storage region and the second storage region are stripes of a volume of a Redundant Array of Independent Disks (RAID),
and/or wherein the first storage device is a processor slave of the RAID for the second storage region,
and/or wherein the second storage device is a processor master of the RAID for the second storage region.

16. The computer system according to claim 1, wherein the first storage device comprises a first storage module and the second storage device comprises a second storage module, wherein the storage region is distributed across the first storage module and the second storage module.

17. The computer system according to claim 1, wherein the request and/or the further request comprise at least one element of the group of a request to write data to the storage region, a request to read data from the storage region and a request to update data within the storage region.

18. The computer system according to claim 1, wherein the first storage device and/or the second storage device are configured to communicate via a non-volatile memory express communication protocol.

19. The computer system according to claim 1, wherein the communication infrastructure is a Peripheral Component Interconnect express (PCIe) communication infrastructure,
and/or wherein the communication infrastructure is a point to point communication infrastructure,
and/or wherein the first storage device is configured to issue the further request to the second storage device using a peer-to-peer connection between the first storage device and the second storage device,
and/or wherein the first storage device is configured to issue the further request to the second storage device without involving the computer system host and/or without involving a central processing unit of the computer system.

20. A controller for a first storage device of a computer system, the controller comprising:
an interface configured to receive, via a communication infrastructure, a request related to a storage region distributed across the first storage device and a second storage device from a computer system host; and
a control module configured to issue a further request to the second storage device via the communication infrastructure to execute the request.

21. The controller according to claim 20, wherein the control module is configured to issue the further request to the second storage device if the request is related to a portion of the storage region stored on the second storage device.

22. A controller for a second storage device of a computer system, the controller comprising:
an interface configured to receive a request related to a storage region distributed across a first storage device and the second storage device from the first storage device via a communication infrastructure; and
a control module configured to execute the request related to the storage region on a portion of the storage region stored on the second storage device.

23. A method for a computer system, the computer system comprising a first storage device, a second storage device and a communication infrastructure, wherein a storage region is distributed across the first storage device and the second storage device, the method comprising
transmitting a request related to the storage region to the first storage device via the communication infrastructure, and
the first storage device issuing a further request to the second storage device via the communication infrastructure to execute the request.
